(19) United States
(12) Patent Application Publication
(10) Pub. No.: US 2002/0070250 A1
(43) Pub. Date: Jun. 13, 2002

(54) Dispenser head and a receptacle provided with such a head

(76) Inventor: Jean-Francois Delage, Paris (FR)

Correspondence Address: OPPENHEIMER WOLFF & DONNELLY LLP, Suite 3800, 2029 Century Park East, Los Angeles, CA, 90067-3024, US

(21) Appl. No.: 09/967,587

(22) Filed: Sep. 28, 2001

(30) Foreign Application Priority Data
Oct. 3, 2000 (FR) 00 12591

(51) Int. Cl. B67D 3/00

(52) U.S. Cl. 222/556

(57) ABSTRACT

An elastically deformable shutter has a first portion attached to a fixed wall of a dispenser head, a second portion attached to a drive member, and a third portion between said first and second portions. The deformable shutter in an open configuration enables substance in a receptacle to flow towards the dispenser orifice. In a closed configuration, the substance is prevented from flowing towards the dispenser orifice. A third portion bears against a wall of the dispenser head in the closed configuration. Passage from one configuration to the other is induced by an action other than pressure from substance in the receptacle.

### FIELD OF THE INVENTION

The present invention relates to packaging and dispensing a substance, in particular a cosmetic or a care product.

### OBJECTS AND SUMMARY OF THE INVENTION

An object of the present invention is to provide a novel dispenser head of relatively simple structure for fitting to a receptacle, the head enabling the content of the receptacle to be isolated from ambient air while not in use, and also reducing any risk of substance leaking out, for example when pressure is exerted accidentally on the receptacle.

According to one aspect of the invention, the dispenser head presents at least one dispenser orifice, and it comprises an elastically deformable shutter suitable for taking up at least two different configurations, namely an open configuration enabling the substance contained in the receptacle to flow towards the dispenser orifice, and a closed configuration preventing the substance contained in the receptacle from flowing towards the dispenser orifice, with passage from one extreme configuration to the other being induced by action other than pressure from the substance contained in the receptacle.

By means of the invention, the content of the receptacle can be isolated from ambient air without any fear of pressure exerted accidentally on the receptacle causing substance to leak out, since the shutter does not change configuration in response to the pressure of the substance contained in the receptacle, contrary to what happens with a check valve, for example.

The fact that the shutter is elastically deformable also makes it possible for closure to be relatively hermetic, which is not always true of conventional dispenser heads.

The force that needs to be exerted on the shutter to cause it to pass from one of its configurations to the other may pass through a maximum in an intermediate configuration.

Thus, the change of shutter configuration can clearly be felt by the user, thus making the dispenser head more comfortable to use.

In a preferred embodiment, the shutter has an annular lip which, when the shutter is in its closed configuration, comes to bear against a wall of the dispenser head so as to prevent substance contained in the receptacle from passing towards the dispenser orifice.

Still in a preferred embodiment, said annular lip is of a shape selected in such a manner that its contact pressure against said wall, when the shutter is in its closed configuration, tends to increase with increasing pressure of the substance.

Thus, any pressure exerted accidentally on the receptacle does not run the risk of causing a leak since the greater the pressure exerted by the substance on the shutter, the greater the tendency of the shutter to oppose passage of the substance.

The shutter preferably includes a portion which has a concave face that changes side when the shutter passes from its closed configuration to its open configuration, and vice versa.

This changeover of concave side causes the force that needs to be exerted to change the configuration of the shutter to pass through a maximum in a configuration that is intermediate between the extreme configurations.

In a preferred embodiment, the shutter has a first part serving to fix the shutter on the dispenser head and presenting a shape that is substantially independent of the configuration of the shutter, and a second part serving to perform the closing function, presenting a shape that differs depending on whether the shutter is in its open or its closed configuration, the first and second parts of the shutter being preferably formed integrally by molding a plastics material, preferably an elastomer.

Advantageously, the shutter is circularly symmetrical in shape, thereby enabling it to be fixed to the dispenser head without any need to comply with some particular orientation about the axis of the receptacle.

In a particular embodiment, the shutter has a preferably central portion secured to a drive member whose movement causes the shutter to change configuration.

The drive member can be a piece fitted on the shutter.

Under such circumstances, the shutter preferably has a central stud fixed to the drive member by being secured thereto as a force-fit, by adhesive, or by heat-sealing.

The shutter can also include a central recess on its side opposite from said stud.

Such a recess can make it easier for the shutter to change state.

The drive member can also be formed integrally by being molded with the shutter, preferably by dual injection of plastics materials.

The shutter can also be made integrally with a portion of the receptacle, by dual injection of plastics materials.

The drive member preferably moves axially on the axis of the dispenser head.

In a particular embodiment, the drive member cooperates with an actuator element that can be driven by the user, movement of the actuator element causing the drive member to move.

The actuator element is preferably rotary, and the drive member co-operates with the actuator element in such a manner that rotary movement of the actuator element is transformed into axial movement of the drive member.

The drive member and the actuator element advantageously co-operate in such a manner that one half-turn of the actuator element relative to the receptacle, performed in either direction of rotation, causes the shutter to change configuration.

The actuator element preferably includes a cover flap arranged to cover the dispenser orifice when the actuator element is in a closed position and the shutter is in its closed configuration, the cover flap being shaped to cease covering the dispenser orifice when the actuator element is in a dispensing position and the shutter is in its open configuration.

The cover flap preferably includes a boss on its inside surface suitable for snapping into the dispenser orifice when the actuator element is in its closed position.

Such snap-fastening is advantageously felt by the user, thus informing the user that the dispenser head is properly closed.

In addition, the above-mentioned snap-fastening increases the force that needs to be exerted on the actuator element to bring into its dispensing position, thereby tending to reduce any risk of the actuator element being moved accidentally.

In a preferred embodiment, the actuator element has a central chimney which presents at least one helical groove co-operating with at least one follower in relief on the drive member, such that rotating the actuator element causes the drive member to move axially.

The above-mentioned chimney can have two helical grooves and the drive member can have two follower pegs each engaged in a respective groove. The central chimney can also have a helical groove that extends in one axial direction over an angular sector of 180°, and in an opposite axial direction over the complementary 180° angular sector, the drive member having a peg engaged in said groove so that each time the actuator element is turned through half a turn in the same direction relative to the receptacle, the drive member moves in a direction opposite to that corresponding to the direction in which it moves during the preceding half-turn.

In a particular embodiment, the actuator element is arranged so as to be capable of rocking between a closed position and a dispensing position.

Under such circumstances, preferably, the actuator element and the drive member include a link comprising a head retained in a cage, the height of the cage corresponding substantially to the height of the head, said head being capable of sliding and pivoting in the cage.

Still in a particular embodiment, the actuator element is hinged on a support piece having two opposite curved walls, and the actuator element includes curved rims of shape complementary to that of said walls.

The invention also provides a receptacle provided with a dispenser head as defined above.

According to one aspect of the invention, the dispenser head presents at least one dispenser orifice, and comprises an elastically deformable shutter comprising a first portion attached to a fixed wall of said dispenser head, a second portion attached to a drive member, and a third portion between said first and second portions, said deformable shutter being suitable for taking up at least two different configurations, namely an open configuration enabling the substance contained in a receptacle to flow towards the dispenser orifice, and a closed configuration preventing the substance contained in the receptacle from flowing towards the dispenser orifice, said third portion bearing against a wall of said dispenser head in said closed configuration, with passage from one configuration to the other being induced by a movement of said drive member.

Said third portion may be an annular lip.

According to one aspect of the invention, the dispenser head presents at least one dispenser orifice, and comprises an elastically deformable shutter suitable for taking up at least two different configurations, namely an open configuration enabling the substance contained in a receptacle to flow towards the dispenser orifice, and a closed configuration preventing the substance contained in the receptacle from flowing towards the dispenser orifice, with passage from one configuration to the other being induced by rotation of an actuator element rotatable about an axis of a neck of the receptacle.

The head may comprise a drive member whose movement causes the shutter to change configuration.

The drive member may co-operate with the actuator element in such a manner that rotary movement of the actuator element is transformed into axial movement of the drive member.

The drive member and the actuator element may cooperate in such a manner that one half-turn of the actuator element relative to the receptacle performed in either direction of rotation causes the configuration of the shutter to change.

According to one aspect of the invention, the dispenser head presents at least one dispenser orifice, and comprises an elastically deformable shutter including a central portion secured to a drive member axially movable, wherein said drive member co-operates with an actuator element that can be driven by the user, movement of the actuator element causing the drive member to move, said shutter being suitable for taking up at least two different configurations, namely an open configuration enabling the substance contained in a receptacle to flow towards the dispenser orifice, and a closed configuration preventing the substance contained in the receptacle from flowing towards the dispenser orifice, with passage from one configuration to the other being induced by action on the actuator element, said actuator element comprising a cover flap arranged to cover the dispenser orifice when the actuator element is in a closed position and the shutter is in its closed configuration, said cover flap being shaped so as to cease to cover the dispenser orifice when the actuator element is in a dispensing position and the shutter is in its open configuration.

Said cover flap may include a boss on its inside surface that is suitable for snapping into the dispenser orifice when the actuator element is in its closed position.

The actuator element may be arranged in such a manner as to be capable of rocking between a closed position and a dispensing position.

The actuator element and the drive member may comprise a link comprising a head retained in a cage.

According to one aspect of the invention, the dispenser head presents at least one dispenser orifice, and comprises an elastically deformable shutter suitable for taking up at least two different configurations, namely an open configuration enabling the substance contained in a receptacle to flow towards the dispenser orifice, and a closed configuration preventing the substance contained in the receptacle from flowing towards the dispenser orifice, with passage from one configuration to the other being induced by an action other than pressure from the substance contained in the receptacle, wherein a force to be exerted on the shutter to cause it to pass from one configuration to the other passes through a maximum in an intermediate configuration.

### BRIEF DESCRIPTION OF THE DRAWINGS

The invention will be better understood on reading the following detailed description of non-limiting embodiments and on examining the accompanying drawings, in which:

FIG. 1 is a diagrammatic and fragmentary axial section of a receptacle fitted with a dispenser head constituting an embodiment of the invention, the shutter being shown in its closed configuration;

FIG. 2 is a view analogous to FIG. 1 showing the shutter in its open configuration;

FIG. 3 is a developed view of the groove formed in the central chimney of the actuator element;

FIG. 4 is a view analogous to FIG. 3, showing a variant embodiment;

FIG. 5 is an axial section on V-V of FIG. 6;

FIG. 6 shows a receptacle fitted with a dispenser head constituting another embodiment of the invention, the actuator element being in the dispensing position;

FIG. 7 is a section on VII-VII of FIG. 8; and

FIG. 8 is a view analogous to FIG. 6, with the actuator element shown in the closed position.

### MORE DETAILED DESCRIPTION

The dispenser head 1 shown in the figures is fitted on a receptacle 2 having an axis X and containing a substance of liquid to semisolid consistency, for example a lotion or a sun cream or a shampoo for the body or the hair, this list not being limiting, the dispenser head also being suitable for fitting to a receptacle containing a washing-up detergent, for example.

The receptacle 2 is provided on top with a neck 6 on the axis X, and the dispenser head 1 has a support piece 3.

This support piece 3 comprises an assembly skirt 4 arranged to snap-fasten on the neck 6 and including, for this purpose, teeth 7 at its bottom end that are suitable for engaging in an annular groove 10 at the base of the neck 6.

The support piece 3 also has a sealing skirt 5 on the same axis X as the receptacle 2, pressing in sealed manner against the inside surface of the neck 6.

The support piece 3 defines a lateral dispenser orifice 11 enabling the substance contained in the receptacle 2 to flow out therefrom.

The dispenser head 1 includes an elastically deformable shutter 15 which is implemented in the present example as a single piece of elastomer plastics material, being circularly symmetrical about the axis X.

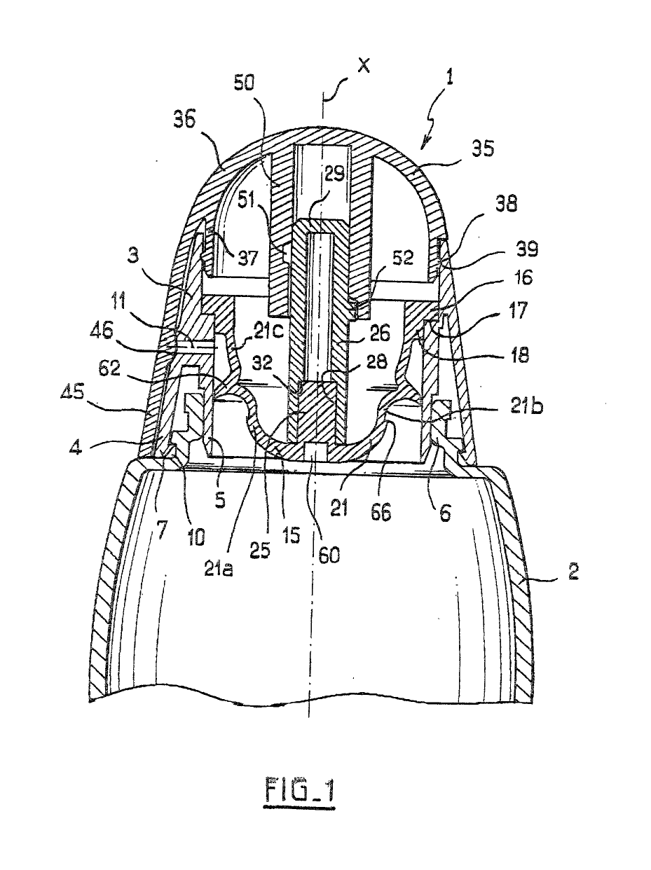

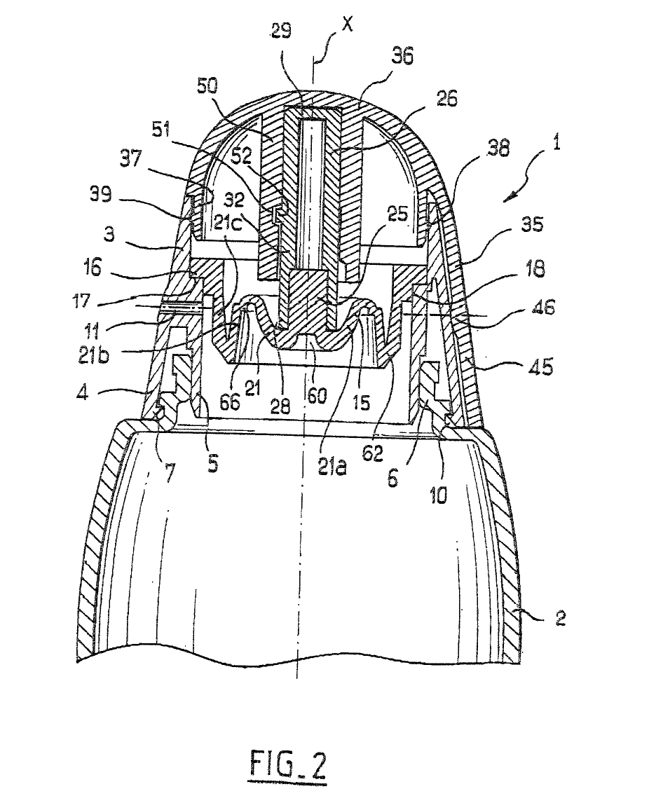

The shutter 15 can take up two extreme configurations, namely a closed configuration as shown in FIG. 1 and an open configuration as shown in FIG. 2, and as described in greater detail below.

In the example described, the shutter 15 has a top part 16 of annular shape with an outwardly directed peripheral shoulder resting axially on a shoulder 17 on the inside of the support piece 3, the shoulder 17 being at the top of the sealing skirt 5 and above the dispenser orifice 11.

The top part 16 also bears radially via a cylindrical surface 18 against the sealing skirt 5 below the shoulder 17.

The top part 16 can be fixed to the support piece 3 by adhesive or by heat-sealing, for example.

In a variant, the shutter 15 can be made integrally with the support piece 3 by dual injection of plastics materials, the support piece being made of a rigid or semi-rigid plastics material while the shutter 15 is made of an elastomer material. Under such circumstances, the top part 16 adheres to the support piece 3 by local melting of the material during the molding process.

The shape of the top part 16 is substantially constant whatever configuration taken up by the shutter 15.

The shutter 15 has a bottom part 21 of shape that differs depending on whether the shutter 15 is in its closed configuration or in its open configuration.

This bottom part 21 includes a central portion 21a provided with an upwardly directed stud 25 on the axis X serving to couple the shutter 15 to a drive member 26 capable of moving axially, the drive member 26 serving to cause the shutter 15 to change configuration, as described in greater detail below.

In the example described, the general shape of the drive member 26 is that of a tube closed at its top end 29 and engaged as a friction fit via its bottom end 28 on the stud 25 until the stud comes into abutment against an internal shoulder 32.

In a variant embodiment, the shutter 15 and the drive member 26 can be made integrally by molding, e.g. by dual injection of plastics materials, with the drive member 26 being made of a rigid or semi-rigid plastics material and the shutter being made of an elastomer material.

The bottom part 21 of the shutter 15 also has a peripheral portion 21b and a connecting portion 21c, which are described below.

The dispenser head 1 has a rotary cap 35 presenting a substantially hemispherical top part 36 extended downwards at its periphery by an assembly skirt 37.

The assembly skirt 37 presents a bead 38 arranged to snap into an annular groove 39 formed at the top end of the support piece 3 so that the cap 35 can turn about the axis X relative to the support piece 3 without moving axially, between a closed position corresponding to FIG. 1, and a dispensing position, corresponding to FIG. 2.

The cap 35 has a lateral cover flap 45 suitable for covering the dispenser orifice 11 in the closed position, as shown in FIG. 1.

A boss 46 is formed on the inside surface of the flap 45 to snap into the dispenser orifice 11 when the cap 35 is in the closed position, with this snapfastening being felt by the user who is thus informed that the receptacle is properly closed.

The flap 45 leaves the dispenser orifice 11 disengaged when the cap 35 is in its dispensing position, as can be seen in FIG. 2.

The cap 35 has a chimney 50 about the axis X, with the top end of the chimney being connected substantially to the top of the top portion 36.

The inside surface of the chimney 50 is provided with a groove 51 that co-operates with a follower peg 52 formed on the outside surface of the top portion of the drive member 26.

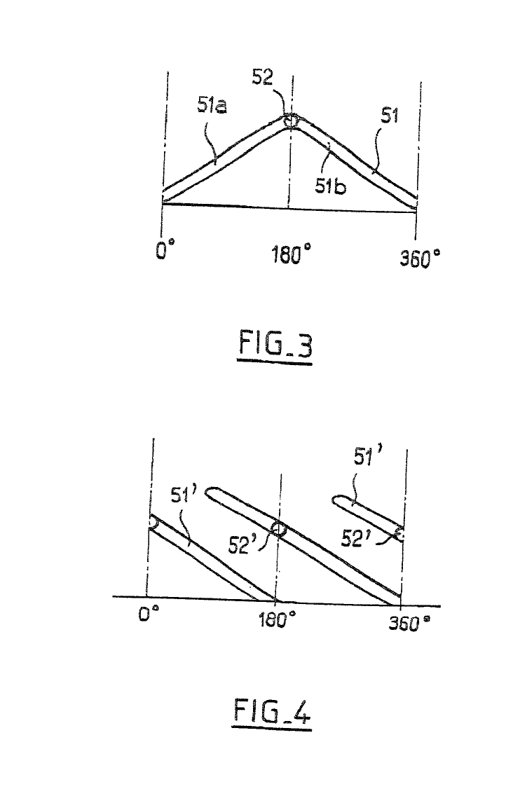

In the embodiment described, and as can be seen in FIG. 3, the groove 51 comprises two helical portions Sla each extending over 180°, these portions being axially directed in opposite directions symmetrically about a plane so that each time the cap 35 is turned through half a turn in the same direction, the drive member 26 is caused to move successively axially upwards and axially downwards.

In other words, any half-turn of the cap 35, whether performed in the same direction as before or in the opposite direction, causes the shutter 15 to change configuration.

In a variant embodiment, the chimney 50 has two helical grooves 51′, and the drive member 26 has two follower pegs 52′ slidably received in respective ones of the grooves 51′, as shown in FIG. 4.

Such a disposition makes it possible to move the drive member 26 in one direction by turning the cap 35 through half a turn, and to move the drive member 26 in the opposite direction by turning the cap through half a turn in the opposite direction.

When the shutter 15 is in its closed configuration, as shown in FIG. 1, the central portion 21a of the bottom part 21 of the shutter 15 is generally in the form of an upwardly concave dish.

It will be observed that the central portion 21a on its side remote from the stud 25 includes a recess 60 which makes the shutter 15 easier to deform.

At its periphery, the central portion 21a is connected to the peripheral portion 21b, which portion has an annular lip 62.

The peripheral portion 21b is connected to the top part 16 of the shutter 15 via the connecting portion 21c which itself is tubular.

The central portion 21a is connected to the peripheral portion 21b in such a manner as to form a small inward step 66 when the shutter is in its open configuration, as can be seen in FIG. 2.

When the shutter 15 is in its open configuration, the outside diameter of the annular lip 62 is smaller than the inside diameter of the sealing skirt 5 and substance can go from the inside of the receptacle 2 to the dispenser orifice 11 by flowing through the annular space formed between the sealing skirt 5, the annular lip 62, and the connecting portion 21c.

The top part 16 of the shutter 15 presses in sealed manner against the support piece 3, thereby preventing substance from flowing other than through the dispenser orifice 11.

In the embodiment described, substance is dispensed by pressing on the wall of the receptacle 2, which wall is flexible, but it would not go beyond the ambit of the present invention for the substance to be brought to the dispenser orifice 11 other than by exerting pressure on the wall of the receptacle, for example by means of a pump.

To close the receptacle, the user turns the cap 35 through half a turn, thereby causing the drive member 26 to move downwards, with this movement being associated with the bottom part 21 of the shutter 15 changing configuration.

This change of configuration causes the annular lip 62 to pivot radially outwards, so that the annular lip 62 comes to press in sealed manner against the sealing skirt 5.

As can be seen in FIG. 1, the annular lip 62 then points downwards.

Any pressure of the substance against the surface 63 of the annular lip 62 situated facing the inside volume of the receptacle 2 will tend to increase the force with which the annular lip 62 is pressed against the sealing skirt 5.

Thus, even if pressure is exerted accidentally on the wall of the receptacle 2, the shutter 15 can prevent the substance from reaching the dispenser orifice 11.

Naturally, the invention is not limited to the embodiment described above.

In particular, the shutter can be made integrally with the drive member other than in the manner described.

It is also possible to omit the flap on the rotary cap or to provide the dispenser orifice with a check valve overmolded on the support piece, or indeed to leave the dispenser orifice permanently disengaged.

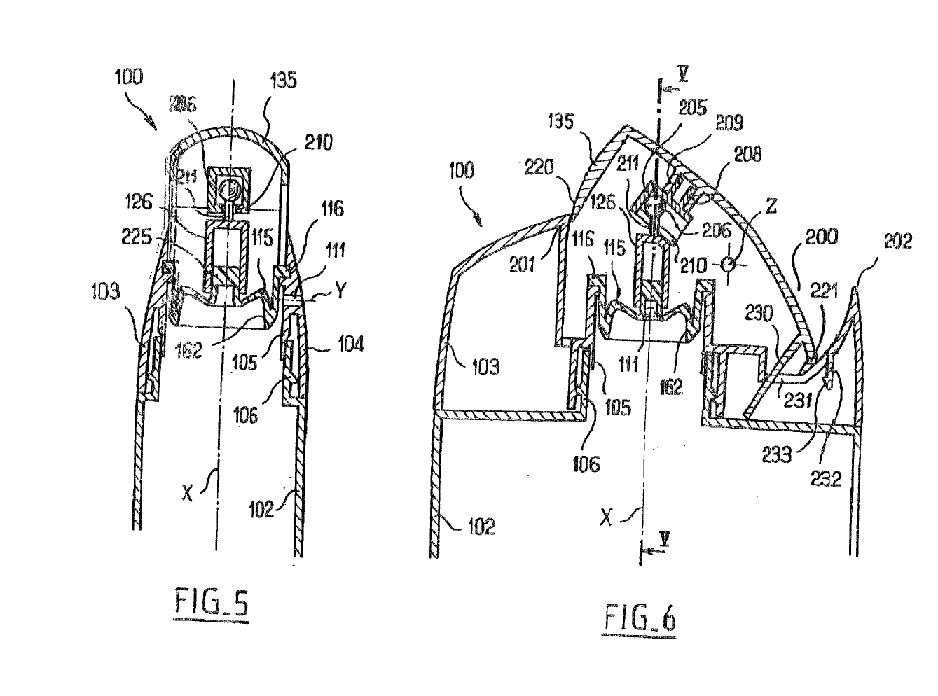

It is also possible to replace the rotary actuator element by a rocking actuator element, as described below with reference to FIGS. 5 to 8.

In these figures, there is shown a device 100 comprising a receptacle 102 provided with a support piece 103 snap-fastened on a neck 106.

The support piece 103 has an outer skirt 104 snapfastened onto the neck 106, and an inner sealing skirt 105 pressing in sealed manner against the inside surface of the neck 106.

A dispenser orifice 111 passes through the support piece 103 on an axis Y perpendicular to the axis X of the receptacle.

The support piece 103 supports a shutter 115 identical to the shutter 15 described above and fixed by an annular part 116 to the support piece 103.

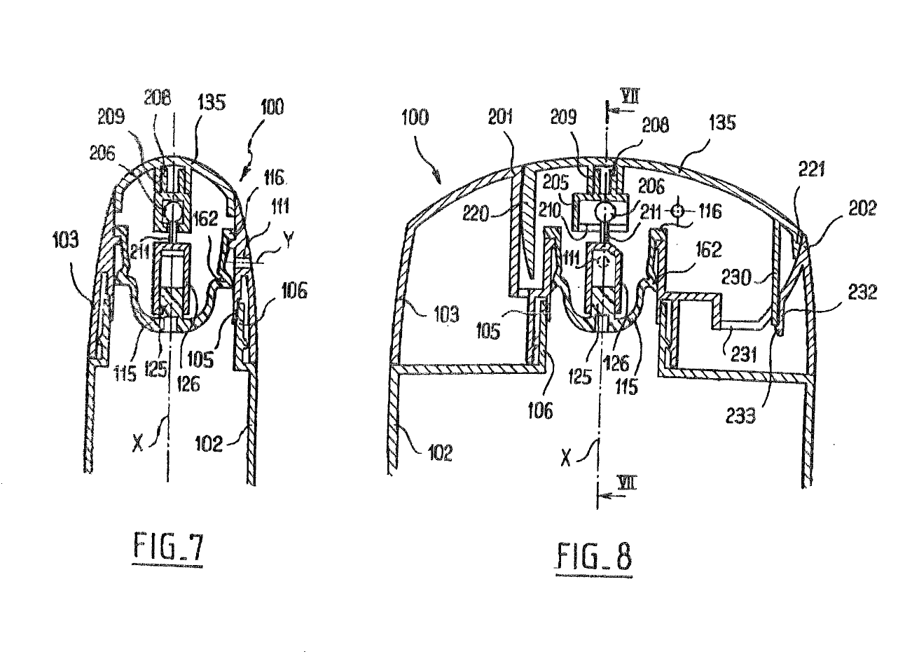

The shutter 115 has an annular lip 162 suitable for pressing in sealed manner against the sealing skirt 105 when the shutter is in its closed configuration, as shown in FIGS. 7 and 8.

The sealing lip 162 then prevents the substance contained in the receptacle 102 from reaching the dispenser orifice 111.

The device 100 also has an actuator element 135 that rocks about an axis Z perpendicular to the axis X and parallel to the axis Y of the dispenser orifice 111.

The actuator element 135 has opposite rims 220 and 221 that are outwardly convex and complementary in shape to edges 201 and 202 of the housing 200 in which the actuator element 135 moves, as can be seen in FIG. 8.

The rim 220 is of a height that is sufficient to ensure that, when the actuator element 135 is in its dispensing position, as shown in FIGS. 5 and 6, the bottom end of the rim 220 still overlaps the edge 201, thereby preventing dirt from penetrating into the housing 200.

The actuator element 135 carries a cage 205 which receives a spherical head 206 situated at the top end of a drive member 126 which serves to cause the shutter 115 to change configuration.

The cage 205 is secured to an endpiece 208 engaged in a housing 209 formed inside the actuator element 135, as can be seen in FIGS. 6 to 8.

The bottom part of the cage 205 has a through slot 210 and the head 206 is connected to the bottom part of the drive member 126 by a rod 211 of diameter smaller than the width of the slot 210.

The drive member 126 has a tubular bottom part forced onto a stud 125 similar to the stud 25 of the above-described shutter 15.

The diameter of the head 206 corresponds substantially to the height of the cage 205, as can be seen in FIGS. 6 and 8, so that rocking the actuator element 135 causes the drive member 126 to move axially, with the head 206 sliding laterally inside the cage 205 during rocking.

The actuator element 135 has a tab 230 close to the rim 221, this tab 230 being engaged in an opening 231 formed through the bottom wall of the housing 200, in the support piece 103.

A tab 232 provided with a catch 233 at its bottom end is placed on one of the edges of the opening 231 so that at the end of the rocking stroke of the actuator element 135 towards the closed position, the tab 130 snaps onto the catch 233.

Thus, the actuator element 135 is held in its closed position by snap-fastening, thus enabling the user to feel clearly when the dispenser head has closed.

To dispense substance, the user presses on the actuator element 135 adjacent to the rim 221, thereby causing the tab 230 to disengage from the cap 233 by elastic deformation, and thus causing the rim 220 to move upwards.

This rocking movement is accompanied by traction being exerted along the axis X by the actuator element 135 on the drive member 126, and by the shutter 115 changing configuration.

In this embodiment, the shutter 115 can be made together with the support piece 103 by dual injection of plastics materials, or it can be constituted by a separate element which is fixed to the support piece 103 by any appropriate means.

1/ A dispenser head presenting at least one dispenser orifice, and comprising an elastically deformable shutter comprising a first portion attached to a fixed wall of said dispenser head, a second portion attached to a drive member, and a third portion between said first and second portions, said deformable shutter being suitable for taking up at least two different configurations, namely an open configuration enabling the substance contained in a receptacle to flow towards the dispenser orifice, and a closed configuration preventing the substance contained in the receptacle from flowing towards the dispenser orifice, said third portion bearing against a wall of said dispenser head in said closed configuration, with passage from one configuration to the other being induced by an action other than pressure from the substance contained in the receptacle.

2/ A dispenser head according to claim 1, wherein said third portion is an annular lip.

3/ A dispenser head according to claim 1, wherein the force to be exerted on the shutter to cause it to pass from one extreme configuration to the other passes through a maximum in an intermediate configuration.

4/ A dispenser head according to claim 2, wherein said annular lip is of a shape that is selected in such a manner that its contact pressure against the wall of the dispenser head when the shutter is in its closed configuration, tends to increase with increasing pressure of the substance.

5/ A dispenser head according to claim 1, wherein the shutter includes a portion which has a concave face which changes side when the shutter passes from its closed configuration to its open configuration, and vice versa.

6/ A dispenser head according to claim 1, wherein the first portion has a shape that is substantially independent of the configuration of the shutter.

7/ A dispenser head according to claim 1, wherein the first and second portions of the shutter are made as a single molding of plastics material.

8/ A dispenser head according to claim 7, wherein said plastics material is elastomer.

9/ A dispenser head according to claim 1, wherein the shutter is circularly symmetrical in shape.

10/ A dispenser head according to claim 1, wherein said second portion is a central portion.

11/ A dispenser head according to claim 10, wherein the drive member is fitted to the shutter.

12/ A dispenser head according to claim 10, wherein said second portion comprises a central stud fixed to the drive member.

13/ A dispenser head according to claim 12, wherein the shutter comprises a central recess on its side remote from said stud.

14/ A dispenser head according to claim 1, wherein the drive member is integrally molded with the shutter.

15/ A dispenser head according to claim 14, wherein the shutter is made by dual injection of plastics materials.

16/ A dispenser head according to claim 1, wherein the shutter is made integrally with a part of the receptacle by dual injection of plastics materials.

17/ A dispenser head according to claim 1, wherein the drive member moves axially on an axis of the dispenser head.

18/ A dispenser head according to claim 1, wherein said drive member co-operates with an actuator element that can be driven by the user, movement of the actuator element causing the drive member to move.

19/ A dispenser head according to claim 18, wherein the actuator element is rotary and wherein the drive member co-operates with the actuator element in such a manner that rotary movement of the actuator element is transformed into axial movement of the drive member.

20/ A dispenser head according to claim 18, wherein the drive member and the actuator element co-operate in such a manner that one half-turn of the actuator element relative to the receptacle performed in either direction of rotation causes the configuration of the shutter to change.

21/ A dispenser head according to claim 18, wherein the actuator element includes a cover flap arranged to cover the dispenser orifice when the actuator element is in a closed position and the shutter is in its closed configuration, said cover flap being shaped so as to cease to cover the dispenser orifice when the actuator element is in a dispensing position and the shutter is in its open configuration.

22/ A dispenser head according claim 21, wherein said cover flap comprises a boss on its inside surface that is suitable for snapping into the dispenser orifice when the actuator element is in its closed position.

23/ A dispenser head according to claim 18, wherein the actuator element includes a central chimney presenting at least one helical groove co-operating with at least one follower in relief of the drive member such that rotation of the actuator element is accompanied by axial displacement of the drive member.

24/ A dispenser head according to claim 23, wherein said central chimney has two helical grooves, and the drive member has two follower pegs each engaged in a respective one of the grooves.

25/ A dispenser head according to claim 23, wherein said central chimney has a helical groove extending in one axial direction over an angular sector of 180° and in the opposite axial direction over the complementary 180° angular sector, and wherein the drive member includes a follower peg engaged in said groove, such that each halfturn of the actuator element relative to the receptacle, when performed in the same direction of rotation, causes the drive member to move in a direction opposite to the direction in which it moved during the preceding halfturn.

26/ A dispenser head according to claim 18, wherein the actuator element is arranged in such a manner as to be capable of rocking between a closed position and a dispensing position.

27/ A dispenser head according to claim 26, wherein the actuator element and the drive member include a link comprising a head retained in a cage, the height of the cage corresponding substantially to the height of the head, said head being capable of sliding and pivoting inside the cage.

28/ A dispenser head according to claim 26, wherein the actuator element is hinged on a support piece including two opposite curved walls and wherein the actuator element has rims of shape complementary to the shape of said walls.

29/ A receptacle provided with a dispenser head according to claim 1.

30/ A dispenser head presenting at least one dispenser orifice, and comprising an elastically deformable shutter suitable for taking up at least two different configurations, namely an open configuration enabling the substance contained in a receptacle to flow towards the dispenser orifice, and a closed configuration preventing the substance contained in the receptacle from flowing towards the dispenser orifice, with passage from one configuration to the other being induced by rotation of an actuator element rotatable about an axis of a neck of the receptacle.

31/ A dispenser head according to claim 30, wherein the head comprises a drive member whose movement causes the shutter to change configuration.

32/ A dispenser head according to claim 31, wherein the drive member co-operates with the actuator element in such a manner that rotary movement of the actuator element is transformed into axial movement of the drive member.

33/ A dispenser head according to claim 31, wherein the drive member and the actuator element co-operate in such a manner that one half-turn of the actuator element relative to the receptacle performed in either direction of rotation causes the configuration of the shutter to change.

34/ A dispenser head presenting at least one dispenser orifice, and comprising an elastically deformable shutter including a central portion secured to a drive member axially movable, wherein said drive member co-operates with an actuator element that can be driven by the user, movement of the actuator element causing the drive member to move, said shutter being suitable for taking up at least two different configurations, namely an open configuration enabling the substance contained in a receptacle to flow towards the dispenser orifice, and a closed configuration preventing the substance contained in the receptacle from flowing towards the dispenser orifice, with passage from one configuration to the other being induced by action on the actuator element, said actuator element comprising a cover flap arranged to cover the dispenser orifice when the actuator element is in a closed position and the shutter is in its closed configuration, said cover flap being shaped so as to cease to cover the dispenser orifice when the actuator element is in a dispensing position and the shutter is in its open configuration.

35/ A dispenser head according claim 34, wherein said cover flap includes a boss on its inside surface that is suitable for snapping into the dispenser orifice when the actuator element is in its closed position.

36/ A dispenser head according to claim 34, wherein the actuator element is arranged in such a manner as to be capable of rocking between a closed position and a dispensing position.

37/ A dispenser head according to claim 34, wherein the actuator element and the drive member comprise a link comprising a head retained in a cage.

38/ A dispenser head presenting at least one dispenser orifice, and comprising an elastically deformable shutter suitable for taking up at least two different configurations, namely an open configuration enabling the substance contained in a receptacle to flow towards the dispenser orifice, and a closed configuration preventing the substance contained in the receptacle from flowing towards the dispenser orifice, with passage from one configuration to the other being induced by an action other than pressure from the substance contained in the receptacle, wherein a force to be exerted on the shutter to cause it to pass from one configuration to the other passes through a maximum in an intermediate configuration.
